(19) United States
(12) Patent Application Publication
(10) Pub. No.: US 2020/0223209 A1
(43) Pub. Date: Jul. 16, 2020

(54) BUILD MATERIAL CONTAINER WRAP

(71) Applicant: HEWLETT-PACKARD DEVELOPMENT COMPANY, LP, Spring, TX (US)

(72) Inventors: David C. Harvey, Corvallis, OR (US); Jeremy Barribeau, Vancouver, WA (US)

(21) Appl. No.: 16/498,723

(22) PCT Filed: Oct. 5, 2017
(86) PCT No.: PCT/US2017/055409

§ 371 Date: Sep. 27, 2019

(51) Int. Cl. B33Y 30/00; B33Y 10/00

(52) U.S. Cl. CPC B33Y 30/00; B29C 64/153; B33Y 10/00

(57) ABSTRACT

Example systems relate to build material containers. In one example, a build material container can include an aperture defined by an external wall of the build material container, a supply latch member located within the aperture defined by the external wall of the build material container, a shrink wrap material covering the external wall of the build material container, and a structurally weaker portion of the shrink wrap material aligned around the aperture.

### BACKGROUND

Additive manufacturing techniques, such as three-dimensional (3-D) printing, can manufacture objects through deposition of successive layers of build material onto a build surface. Build material may be deposited onto the build surface. Portions of the build material may then be selectively solidified, and the process may be repeated until the 3-D object is fully manufactured.

### BRIEF DESCRIPTION OF THE DRAWINGS

FIG. 1 illustrates an example build material container wrap consistent with the present disclosure.

FIG. 2 illustrates an example build material container consistent with the present disclosure.

FIG. 3 illustrates an example build material container wrap consistent with the present disclosure.

FIG. 4 illustrates an example build material container consistent with the present disclosure.

FIG. 5 illustrates an example build material container consistent with the present disclosure.

### DETAILED DESCRIPTION

A number of systems and devices for build material container wrap are described herein. In some examples, a device utilizing wrap material can include a build material container. The build material container may comprise an enclosure to encase a build material. In some examples the material container may be utilized for a 2-D printer, for example the material container could contain toner. In other examples, the build material container can be utilized with a manufacturing device such as a 3-D printing device.

In some examples, the wrap material can be loosely positioned over a build material container, and when the wrap material is exposed to an energy source the wrap material can shrink to adhere to the shape of the build material container. For example, the wrap material can be designed to accommodate the specific shape of the build material container such that information may be legibly obtained from the wrap material. For example, the wrap material can be manufactured to have a back side and a front side and include printed information on the front side to indicate the contents and other details of the build material container as described herein. The wrap material may further comprise a structurally weaker portion that is aligned to obstruct a predetermined location on the build material container and when an energy source is applied to shrink the wrap material it adheres it to the build material container using a frictional force to impede rotation of the wrap material.

The structurally weaker portion of the wrap material may include perforations in the wrap material. The structural weakness can also include round hole perforations, square hole perforations, slot hole perforations, various scoring and/or other perforation types. The structurally weaker portion can be permanently removeable to expose one or more supply latch members located within an aperture of the build material container. The supply latch members may couple to a spring latch mechanism of a manufacturing device when the structurally weaker portion of the build material container is removed.

The wrap material and/or structurally weaker portion of the wrap material can also operate as an indicator to a user. For example, the wrap material can indicate that the build material container is unused when the structurally weaker portion of the wrap material is covering the supply latch members and aperture of the build material container. In another example, the build material container can be formed from a translucent material and/or have portions that are translucent. The wrap material and/or structurally weaker portion can cover the translucent portion to provide an indicator to the user. For example, when the structurally weaker portion is removed, a level of build material can be viewed through the translucent portion of the build material container to indicate a level of build material inside the build material container.

In some examples, the structurally weaker portion can obstruct at least one supply latch member within the aperture from coupling to the spring latch mechanism of a manufacturing device. By obstructing the supply latch member within the aperture, the structurally weaker portion can prevent the build material container from being utilized or coupled to the manufacturing device. Thus, the structurally weaker portion can indicate to the user that the build material container is fresh and has not had a first use.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

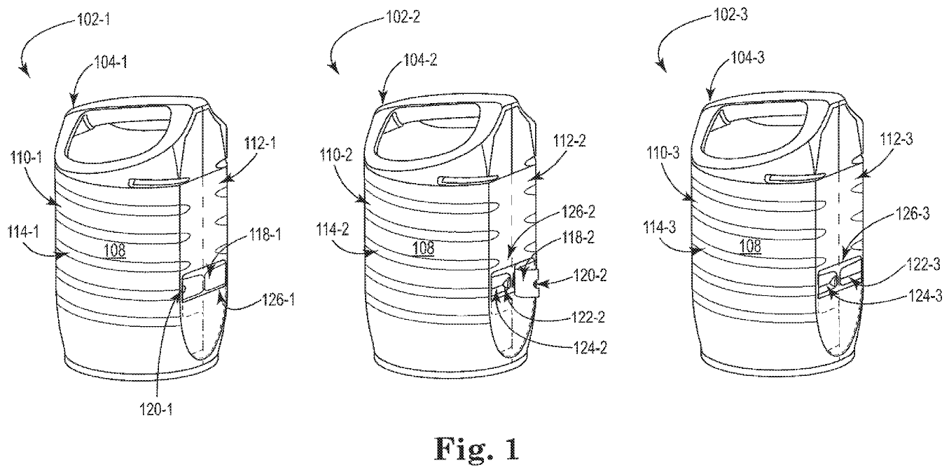

FIG. 1 illustrates an example build material container wrap consistent with the present disclosure. In some examples, FIG. 1 can illustrate a number of build material containers 102-1, 102-2, 102-3. The build material containers 102-1, 102-2, 102-3 can be utilized for storing build material utilized for additive manufacturing. For example, the build material containers 102-1, 102-2, 102-3 can be used with part of a 3-D printing system for generating 3-D objects. In some examples, the build material stored by the build material containers 102-1, 102-2, 102-3 can be spread over a build area of the 3-D printing system.

For example, additive manufacturing techniques, such as 3-D printing, may involve deposition of build material onto the build area. As used herein, a build material refers to a material able to be deposited and selectively solidified to create a 3-D object. A build material may be a thermoplastic powder, a powdered metal material, powdered plastic material, powdered resin material, or any other material suitable for use in additive manufacturing. A build area may refer to a portion of a build surface onto which build material is deposited. In addition, the examples provided are intended to illustrate the examples of the present disclosure, and should not be taken in a limiting sense.

In some examples, the build material encased in the build material containers 102-1, 102-2, 102-3 may be a metal or metal alloy. For example, the build material container 102-1, 102-2, 102-3 may contain metal or metal alloy fine particles or powders. In another example, non-metal elements may be used in the build material container. For example, plastics, bio-based resins, graphite, graphine, bio-ink, paper, edible materials, wearable fibers, concrete, etc. In other examples, powders may be formed from or may include, short fiber build materials that may, for example, have been cut into short lengths from long strands or threads of material. In addition, the examples provided are intended to illustrate the examples of the present disclosure, and should not be taken in a limiting sense.

In some examples, the build material can be selectively solidified utilizing a 3-D printing system using printer agents and powder-like build materials. In an example, a 3-D printing system can use a thermal energy absorber, (e.g., a fusing agent, a printing agent, etc.). The printing agent in this example, can be a dark colored (e.g., black) thermal absorber and/or a light or colorless thermal absorber (e.g., Ultraviolet (UV) absorbers). In this example, the system may also use an additional agent or a detailing agent used to modulate the effect of the fusing agent and/or to provide cooling. The printing agent can also include energy absorption retarding printing agents and/or a moderating printing agent that modifies a degree of coalescence of the build material.

In some examples, the printing agent can be deposited on portions of the build material to solidify the portions with deposited printing agent to selectively inhibit the material. In some examples, printing agent can be utilized to increase the temperature of the build material with deposited printing agent compared to the temperature of the build material without deposited printing agent.

In another example, a system can utilize a chemical binder (e.g. an adhesive agent). In other examples, no agents are used and the build material is selectively melted with a laser beam. In some examples, 3-D printing systems utilize a fusing agent (e.g. high-speed sintering) without other binding agents.

In some examples, the build material containers 102-1, 102-2, 102-3, can include a cylindrical portion 110-1, 110-2, 110-3; and a flat portion 112-1, 112-2, 112-3. The build material container 102-1, 102-2, 102-3 can include a handle 104-1, 104-2, 104-3 and a base portion illustrated in FIG. 1 at the bottom of the build material containers 102-1, 102-2, 102-3. The handle 104-1, 104-2, 104-3 can be utilized by a user to grip the build material containers 102-1, 102-2, 102-3 and move the build material containers 102-1, 102-2, 102-3 to multiple locations. In some examples, the build material containers 102-1, 102-2, 102-3 can have a length of 400-500 millimeters when measured from the base portion to the handle 104-1, 104-2, 104-3; and the base portion illustrated in FIG. 1 at the bottom of build material container, 102-1, 102-2, 102-3 can have a height and width of 150-250 millimeters.

In some examples the build material containers 102-1, 102-2, 102-3 can include a plurality of external ribs 114-1, 114-2, 114-3 on the cylindrical portion 110-1, 110-2, 110-3. The plurality of external ribs 114-1, 114-2, 114-3 can give the cylindrical portion 110-1, 110-2, 110-3 an uneven texture. In some examples, the plurality of external ribs is a relatively lower elevation than other areas of the external surface. For example, the plurality of external ribs 114-1, 114-2, 114-3 can be indented portions of the build material container 102-1, 102-2, 102-3. In some examples, the plurality of external ribs 114-1, 114-2, 114-3 can be generated by a molding process to generate a plurality of corresponding internal ribs on the interior surface of the build material container 102-1, 102-2, 102-3. In some examples, the internal ribs can be generated in an auger shape to promote movement of the build material toward an opening when the container is rotated in an appropriate direction. For example, the internal ribs can be utilized by a manufacturing device to remove the build material from the interior cavity to an external build space.

In some examples, the build material containers 102-1, 102-2, 102-3 as described may be made by several manufacturing processes of container molding. In some examples, the build material containers 102-1, 102-2, 102-3 may be made by blow molding. Blow molding is a manufacturing process by which hollow plastic parts are formed, it can also be used in the formation of glass containers and bottles. For example, extrusion blow molding, injection blow molding, and injection stretch blow molding can form build material containers as described herein. In some examples, the build material containers 102-1, 102-2, 102-3 have a plurality of external ribs as a result of blow molding. The external ribs 114-1, 114-2, 114-3 give the exterior of the build material container an uneven texture, the ribs form areas that are raised in elevation greater than the elevation of other areas on the exterior of the build material containers 102-1, 102-2, 102-3. The interior of a blow molded container as described is similar in texture, uneven with areas that are more elevated than the elevation of others.

In some examples, build material containers 102-1, 102-2, 102-3 can be covered by a wrap material 108 covering the plurality of external ribs 114-1, 114-2, 114-3. In some examples, the wrap material 108 can cover the cylindrical portion 110-1, 110-2, 110-3 for an even texture. In some examples, the wrap material 108 may not cover the handle 104-1, 104-2, 104-3 or a bottom portion as illustrated in FIG. 1.

In some examples, the material used to create the wrap material 108, also delineated throughout this application as shrink wrap material 108, may be comprised of a polymer material. The material used may be varied materials that shrink when exposed to an energy source. For example, PolyVinyl Chloride (PVC), Polyethylene, Polypropylene, Polyolefin and several other compositions. The material used to create the wrap material may be made to shrink in one direction (unidirectional or mono-directional) or in both directions (bidirectional). In addition, the examples provided are intended to illustrate the examples of the present disclosure, and should not be taken in a limiting sense.

In some examples, the energy used to induce the shrinking capabilities of the wrap material 108 may be in the form of heat. The energy source may be applied to the shrink wrap material 108 using a handheld heat gun. In some examples, the shrink wrap material 108, and the build material container 102-1, 102-2, 102-3 it is designed to wrap, may be passed together through a heat tunnel utilizing a conveyor. In other examples, a device similar to an oven may be utilized to apply the energy to shrink the wrapping material 108. In the preceding examples, the various energy sources may be powered by electricity, gas or utilizing another energy source.

In some examples, the shrink wrap material 108 may include printed information on the front, sides or back of the material. The written information may include various metrics that may be pertinent to a user such as intended contents, storage instructions, date of manufacture, name of manufacture, location of manufacture, weight, color, artwork, etc. In some examples, the written information may include other written information that is relevant to the regulatory compliance pertaining to the contents of the container encased in the build material container. For example, information to comply with the Occupational Safety and Health Administration (OSHA), Food and Drug Administration (FDA), Federal Aviation Association (FAA), hazardous waste communications, environmental waste and recycling communications, etc. In addition, the examples provided are intended to illustrate the examples of the present disclosure, and should not be taken in a limiting sense.

In some examples, the shrink wrap material 108 can include a front side and a back side. In these examples, the front side can include printed information that may include metrics describing the contents, weight, or other information relating to the build material stored in the build material container. As used herein, the application of the shrink wrap material 108 may include the material being applied loosely over the cylindrical portion 110-1, 110-2, 110-3 and when an energy source is applied to the material, the material can shrink resulting in a frictional force between the shrink wrap material 108, and the cylindrical portion 110-1, 110-2, 110-3 thereby impeding rotation of the wrap relative to the container.

In some examples, the flat portion 112-2, 112-3 can include an aperture 124-2, 124-3 and one or more supply latch members 122-2, 122-3 positioned within the aperture 124-2, 124-3. As described herein, the aperture 124-2, 124-3, is a cavity of hollow space that may surround the one or more supply latch members 122-2, 122-3 such that the supply latch members 122-2, 122-3 are positioned at or below the surface of the flat portion 112-2, 112-3.

In some examples, the shrink wrap material 108 can include a structurally weaker portion 118-1, 118-2 defined by a border 126-1, 126-2, 126-3. The border 126-1, 126-2, 126-3 defines the area outside the structurally weaker portion 118-1, 118-2. The structurally weaker portion 118-1, 118-2 is a portion that is permanently removeable to expose the supply latch members 122-2, 122-3. For example, a user may grip a tab 120-1, 120-2, and exert a pulling force to remove the structurally weaker portion. In another example, a device may grip a tab 120-1, 120-2 and exert a pulling force to remove the structurally weaker portion 118-1, 118-2.

The tab 120-1, 120-2 may comprise a notch of missing shrink wrap material 108. In another example, the tab 120-1, 120-2 may be a raised portion of additional shrink wrap material 108. In another example, the tab 120-1, 120-2 may be a strip portion of shrink wrap material 108 that is peeled away from the flat portion 112-1, 112-2 to operate as handles. In another example, the tab 120-1, 120-2 may be a looped portion of shrink wrap material 108 that is peeled away from the flat portion 112-1, 112-2 to operate as a ring to pull the structurally weaker portion 118-1, 118-2 off of the remaining shrink wrap material 108.

In some examples, the structurally weaker portion 118-1, 118-2 is a portion that is permanently removeable. The permanently removable portion is delineated by the border 126-1, 126-2, 126-3 and further defines an area outside the structurally weaker portion 118-1, 118-2 such that, the area outside of the structurally weaker portion 118-1, 118-2 is not removeable.

In some examples, an intact presence of the structurally weaker portion 118-1 operates as a visual indicator to the user that the content of build material container 102-1 is fresh and has not had a first use. For example, a visual comparison of the differences in the state of build material container 102-1, 102-2 can provide an indication that the build material container 102-1 is a new container and has not been utilized by a manufacturing device. When intact as shown in build material container 102-1, the structurally weaker portion 118-1 operates as an obstruction, preventing access to the one or more supply latch members 122-2 within the aperture 124-2. The obstruction provided by the structurally weaker portion 118-1 can prevent coupling to the spring latch mechanism of a manufacturing device. As described herein, the obstructive properties of the structurally weaker portion 118-1 (intact) as is the state of build material container 102-1 is a visual indicator to the user that the container has not been coupled to a spring latch mechanism of a manufacturing device.

The absence of the structurally weaker portion 118-1 indicates to a user that the build material container 102-3 is potentially not fresh and/or has had a first use. For example, a user can visually compare the differences in state of build material container 102-1, 102-3. When intact as shown in build material container 102-1, the structurally weaker portion 118-1 operates as an obstruction, preventing access to the one or more supply latch members 122-2 within the aperture 124-2; therefore, preventing coupling to the spring latch mechanism of a manufacturing device. When the structurally weaker portion is permanently removed as illustrated by the state of build material container 102-3, aperture 124-3 and one or more supply latch members 122-3 are exposed, allowing the build material container 102-3 to be coupled to a spring latch mechanism of a manufacturing device. The exposure of aperture 124-3 and one or more supply latch members 122-3 serves as a visual indicator regarding the state of the contents of build material container 102-3 as potentially having a first use.

In some examples, it may be desirable to use an adhesive to further secure the wrap material 108, to the cylindrical portion 110-1, 110-2, 110-3 thus further impeding rotation. For example, the adhesive may be heat activated, or activated by another energy source. In some examples, the adhesive may be applied first to the build material container 102-1, 102-2, 102-3. In other examples, the adhesive may be first applied to the wrap material 108. For example, the structurally weaker portion 118-1, 118-2 to be positioned precisely over a specific area, in which case the adhesive could be positioned on the build material container 102-1, 102-2, 102-3 in the specifically chosen area. For example, it may be desirable to apply the heat activated adhesive around the aperture 124-2, 124-3 to further impede rotation of the shrink wrap material 108, and to maintain alignment of border 126-1, 126-2, 126-3 with the aperture 124-2, 124-3. In this example, a relatively small amount of heat activated adhesive may be applied to maintain said alignment and to prevent rotation of the shrink wrap material 108.

Build material container 102-1, 102-2, 102-3 can provide build material for Additive Manufacturing. As described above, wrap material 108, can include a removeable structurally weaker portion 118-1, 118-2 that obstructs the supply latch member 122-2, 122-3. The presence or absence of the structurally weaker portion 118-1, 118-2 is a visual identifier to the user that the build material container 102-1, 102-2, 120-3 may have had a first use.

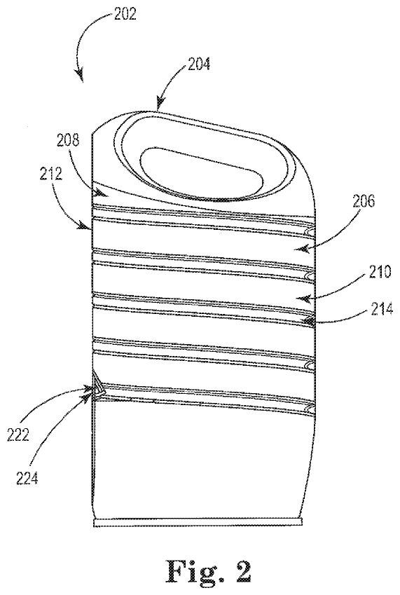

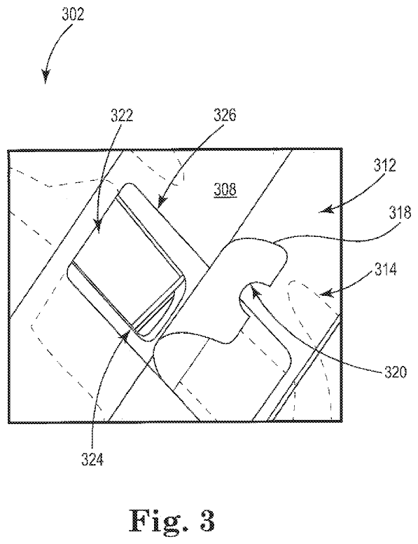

FIG. 2 illustrates an example build material container consistent with the present disclosure. In some examples, FIG. 2 can illustrate a build material container 202. For illustrative purposes, shrink wrap material 208 is transparent in this example so that the aperture 224, at least one supply latch member 222, external wall 206 and external ribs 214 may be clearly understood. The cylindrical portion 210 is visible and the uneven texture created by the plurality of external ribs 214 with indented portions are visible. In this example, the shrink wrap material 208 operates in the same manner as explained in FIG. 1 above and FIG. 3 below.

In some examples, the build material container 202 can include a plurality of external ribs 214 on the cylindrical portion 210. The plurality of external ribs 214 can give the cylindrical portion 210 an uneven texture. In some examples, the plurality of external ribs 214 are at a relatively lower elevation than other areas of the external surface. For example, the plurality of external ribs 214 can be indented portions of the build material container 202. In some examples, the plurality of external ribs 214 can be generated by a molding process to generate a plurality of corresponding internal ribs on the interior surface of the build material container 202. In some examples, the internal ribs can be generated in an auger shape to promote movement of the build material toward an opening. For example, the internal ribs can be utilized by a manufacturing device to remove the build material from the interior cavity to an external build space.

In this example, the external wall 206 is visible and defines the aperture 224 and at least one supply latch member 222. In this example, the absence of the shrink wrap material shown in FIG. 1 as 108, the aperture 224 and at least one supply latch member 222 are unobstructed and may couple to the spring latch mechanism of a manufacturing device.

In this example, shown by FIG. 2, shrink wrap material 208 is transparent, however a user would have a visual indicator as described in FIG. 1 above and FIG. 3 below, to determine if the contents of the build material container 202 had a previous first use or if the build material was fresh. The visual indicator provided by shrink wrap material 208 indicates a potential first use if aperture 224 and at least one supply latch member 222 are visible and unobstructed.

FIG. 3 illustrates an example build material container wrap consistent with the present disclosure. In some examples, FIG. 3 can illustrate build material container 302. The flat portion 312 of the build material container 302 is wrapped by shrink wrap material 308. Shrink wrap material 308 is of the same material illustrated and described above in FIG. 1, delineated as 108. The border 326 defines the area around the aperture 324 which contains at least one supply latch member 322 and structurally weaker portion 318 which further comprises tab 320.

In this example, the aperture 324 and at least one supply latch member 322 are partially obstructed by the structurally weaker portion 318. This is an example of structurally weaker portion 318 in the process of being removed to expose supply latch member 322. For example, after the structurally weaker portion 318 is removed, the aperture 324 and at least one supply latch member 322 would be exposed. The exposure of aperture 324 and at least one supply latch member 322 render them unobstructed, and could potentially be coupled to the spring latch mechanism of a manufacturing device.

In this example, shrink wrap material 308 is partially obstructing supply latch member 322. When the obstruction by structurally weaker portion 318 is removed to expose supply latch member 322 a user would have a visual indication that the build material container 302 may have had a first use.

In another example, the strength of the structurally weaker portion 318 is such that the insertion of the build material container 302 into a printer does not break-off structurally weaker portion 318. In this example, the structurally weaker portion 318 prevents build material container 302 from a first use until structurally weaker portion 318 has been removed.

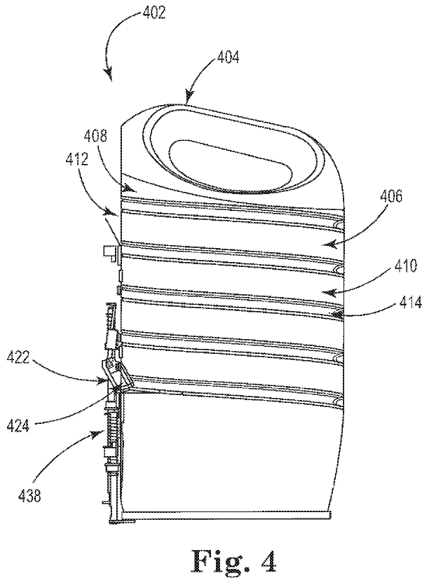

FIG. 4 illustrates an example build material container consistent with the present disclosure. In some examples, FIG. 4 can illustrate build material container 402. For illustrative purposes, shrink wrap material 408 is transparent in this example so that the aperture 424, at least one supply latch member 422, external wall 406 and external ribs 414 may be clearly understood. The cylindrical portion 410 is visible and the uneven texture created by the plurality of external ribs 414 are visible. In this example, the external wall 406 is visible and defines the aperture 424 and at least one supply latch member 422 on flat portion 412. In this example, the shrink wrap material 408 operates in the same manner as explained in FIGS. 1 and 3. In this example, the aperture 424 and at least one supply latch member 422 are unobstructed and coupled to the spring latch mechanism of a manufacturing device 438.

In some examples, the build material container 402 can include a plurality of external ribs 414 on the cylindrical portion 410. The plurality of external ribs 414 can give the cylindrical portion 410 an uneven texture. In some examples, the plurality of external ribs 414 are at a relatively lower elevation than other areas of the external wall 406. For example, the plurality of external ribs 414 can be indented portions of the build material container 402. In some examples, the plurality of external ribs 414 can be generated by a molding process to generate a plurality of corresponding internal ribs on the interior surface of the build material container 402. In some examples, the internal ribs can be generated in an auger shape to promote movement of the build material toward an opening. For example, the internal ribs can be utilized by a manufacturing device to remove the build material from the interior cavity to an external build space.

In this example, illustrated by FIG. 4, shrink wrap material 408 is transparent, however a user would have a visual indicator as described in FIGS. 1 and 3, to determine if the contents of the build material container 402 had a previous first use or if the build material was fresh. The visual indicator provided by shrink wrap material 408 indicates a potential first use if aperture 424 and at least one supply latch member 422 are visible and unobstructed. As illustrated here, the aperture 424 and at least one supply latch member 422 are visible, unobstructed and coupled to the spring latch mechanism of the manufacturing device 438.

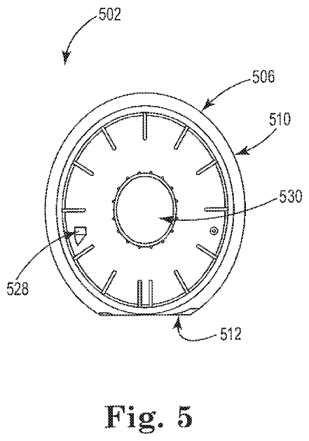

FIG. 5 illustrates an example build material container consistent with the present disclosure. In some examples, FIG. 5 illustrates build material container 502. In this example, the aperture for dispensing build material 530, the cylindrical portion 510, flat portion 512 and the external wall 506 are illustrated with a microprocessor 528 located near the aperture for dispensing build material 530. In some examples, microprocessor 528 may be an acumen. For example, microprocessor 528 could be a smart memory and/or a secure memory.

In this example, microprocessor 528 can indicate a status of build material inside the build material container 502. A user could install the build material container 502, and the manufacturing device would interact with the microprocessor to determine a status of the build material and the build material container 502.

In some examples, it may be beneficial to include a microprocessor 528 on a build material container 502 in addition to the shrink wrap material indicator 308 as illustrated in FIG. 3. It may also be beneficial to relocate the microprocessor elsewhere on the build material container 502. For example, on the external wall 506 of the flat portion 512. Alternatively, the microprocessor 528 could be located on the external wall 506 of the cylindrical wall 510.

In some examples, microprocessor 528 may be used as an indicator for the status of a build material container 502, or the contents of the build material container 502. In some examples, the microprocessor 528 may be located on the bottom of the build material container 502 and may interact with a manufacturing device to provide the user with information about the status of the build material container 502. In other examples, it may be beneficial to obstruct the microprocessor with the structurally weaker portion 318 of the wrap material 308 as illustrated in FIG. 3. When the user grips the tab 320 on the structurally weaker portion 318 of the wrap material 308 and exerts a pulling force, the structurally weaker portion 318 is permanently removed, thus removing the obstruction from the microprocessor. The presence or absence of the structurally weaker portion of the wrap material obstructing access to the microprocessor 528 is a visual identifier to the user of a status of the build material container.

In this example, build material container 502 is coupled to microprocessor 528. It may be beneficial to obstruct the microprocessor 528 with the shrink wrap material 308 of FIG. 3, such that the structurally weakened portion 318 of FIG. 3 is aligned to obstruct the microprocessor 528. Thus, the removal of the structurally weakened portion 318, serves as a visual indicator to the user of a status of the build material container 502.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of” an element and/or feature can refer to any number of such elements and/or features.

What is claimed:

1. A material container, comprising:
an aperture defined by an external wall of the material container;
a supply latch member located within the aperture defined by the external wall of the material container;
a shrink wrap material covering the external wall of the material container; and
a structurally weaker portion of the shrink wrap material aligned around the aperture.

2. The material container of claim 1, wherein the structurally weaker portion of the shrink wrap material is permanently removable to expose the supply latch member within the aperture defined by the external wall.

3. The material container of claim 2, wherein the exposure of the supply latch member enables the material container to couple to a manufacturing device.

4. The material container of claim 1, wherein the supply latch member is obstructed when covered by the structurally weaker portion of the shrink wrap material.

5. The material container of claim 1, wherein the presence of the structurally weaker portion of the shrink wrap material is a visual indicator that the material container contents have not had a first use.

6. The material container of claim 1, wherein the material container includes a cylindrical portion and a flat portion.

7. The material container of claim 1, wherein a handle of the material container and an aperture for dispensing build material is exposed by the shrink wrap material.

8. A system, comprising:
a container to store build material within a cavity defined by an internal wall, wherein a texture of an external wall of the container includes a plurality of ribs;
an aperture defined by the external wall of the container;
an at least one supply latch member located within the aperture defined by the external wall;
a shrink wrap material covering the external wall of the container; and
a structurally weaker portion of the shrink wrap material is aligned to obstruct the at least one supply latch members and the structurally weaker portion is permanently removeable, wherein the permanent removal of the structurally weaker portion of the shrink wrap material exposes the at least one supply latch member within the aperture defined by the external wall.

9. The system of claim 8, wherein the structurally weaker portion of the shrink wrap material is defined by a border that is a same shape of the aperture defined by the external wall.

10. The system of claim 8, wherein the structurally weaker portion of the shrink wrap material includes a tab.

11. The system of claim 8, wherein an area surrounding the structurally weaker portion includes an area that is non-removable,

12. A build material container for a three-dimensional (3-D) printing system, comprising:
a cavity defined by an internal wall that includes a plurality of internal ribs and an external wall that includes a plurality of external ribs, wherein the container includes a cylindrical portion and a flat portion;
an aperture defined by the external wall of the container positioned on the flat portion;
at least one supply latch member located within the aperture defined by the external wall;
a shrink wrap material covering the cylindrical portion and the flat portion of the external wall; and
a perforated section of the shrink wrap material aligned to obstruct and at least one supply latch member positioned on the flat portion, wherein at least one supply latch member is exposed when the perforated section of the shrink wrap material is permanently removed from the container.

13. The system of claim 12, wherein the plurality of internal ribs function to move build material within the container when the container is rotated.

14. The system of claim 12, wherein the shrink wrap material includes a heat activated adhesive positioned around the perforated section.

15. The system of claim 12, wherein the removal of the perforated section of the shrink wrap material indicates a state of the build material container.
